(19) United States
(12) Patent Application Publication
(10) Pub. No.: US 2014/0183103 A1
(43) Pub. Date: Jul. 3, 2014

(54) OIL SAND PROCESS LINE CONTROL

(71) Applicant: Suncor Energy Inc., Calgary (CA)

(72) Inventor: Ramesh KADALI, Fort McMurray (CA)

(73) Assignee: Suncor Energy Inc., Calagary (CA)

(21) Appl. No.: 14/093,310

(22) Filed: Nov. 29, 2013

Related U.S. Application Data
(60) Provisional application No. 61/732,134, filed on Nov. 30, 2012.
(60) Provisional application No. 61/777,825, filed on Mar. 12, 2013.

(30) Foreign Application Priority Data
Sep. 27, 2013 (CA) 2828530

(51) Int. Cl. C10G 1/04; G05B 19/04

(52) U.S. Cl. CPC C10G 1/047; G05B 19/04
USPC 208/390; 196/14.52; 700/159

(57) ABSTRACT

An apparatus and a method for operating a process line for processing mined oil sand ore into a bitumen-containing slurry. The method may include: collecting, at least at one location, a plurality of measurements from one or more sensors; computing at a central controller a calculated value based on at least one of the plurality of measurements; and, applying an adjustment to an operating variable of a component of the process line to override a target set-point of a regulatory controller for that component based on the calculated value and a target value for the calculated value. The method and apparatus may receive measurement values in at least one step, and apply a correction to future measurement values in another step.

### CROSS REFERENCE TO RELATED APPLICATIONS

This application claims priority to U.S. Provisional Application No. 61/732,134, filed Nov. 30, 2012, U.S. Provisional Application No. 61/777,825, filed Mar. 12, 2013 and Canadian Patent Application No. 2,828,530, filed Sep. 27, 2013, all of which are hereby incorporated by reference in their entirety.

### FIELD OF THE INVENTION

This invention relates to mining and processing hydrocarbons from oil sand. In particular, this invention relates to a system and method of automating the mining and processing of hydrocarbons from oil sand.

### BACKGROUND

The Northern Alberta oil sands are considered to be one of the world's largest remaining oil reserves. The oil sands are typically composed of about 70 to 90 percent by weight mineral solids, including sand and clay, about 1 to 10 percent by weight water, and a bitumen or oil film, that comprises from trace amounts up to as much as 21 percent by weight. Typically ores containing a lower percentage by weight of bitumen contain a higher percentage by weight of fine mineral solids (“fines”) such as clay and silt.

Unlike conventional oil deposits, the bitumen is extremely viscous and difficult to separate from the water and mineral mixture in which it is found. Generally speaking, the process of separating bitumen from oil sands extracted through surface mining comprises five broad stages: 1) initially, the oil sand is excavated from its location and passed through a crusher or comminutor to comminute the chunks of ore into smaller pieces; 2) the comminuted ore is then typically combined with a process fluid, such as hot process water, to aid in liberating the oil (the combined oil sand and process fluid is typically referred to as an “oil sand slurry”, and other agents, such as flotation aids may be added to the slurry); 3) the oil sand slurry is passed through a “conditioning” phase in which the slurry is allowed to mix and dwell for a period to create froth in the mixture; 4) once the slurry has been conditioned, it is typically passed through a series of separators for separating the bitumen froth and the tailings from the oil sand slurry as part of an extraction process; and 5) after the maximum practical amount of bitumen has been separated, the remaining tailings material is typically routed into a tailings pond for separation of the sand and fines from the water, and the resulting bitumen product directed to downstream upgrading and refining operations.

In part due to the geographical location of the oil sands, and in part due to the characteristics of oil sand, equipment used to excavate and process oil sand is prone to excessive wear and breakage. For example, during the winter, when temperatures are low, the winter oil sand ore is extremely hard, similar to hard rock. Equipment tends to be brittle and susceptible to breakage when contacted with the hard winter ore. In the summertime, when temperatures are high, the oil sand ore is soft, tacky and highly abrasive. Equipment tends to be abraded and moving surfaces more likely to be contacted with a tacky coating of sand and bitumen.

### SUMMARY

In an implementation, a method is provided for processing mined oil sand ore into a bitumen-containing slurry on a process line, comprising components of the process line performing the steps of: a) receiving loads of mined oil sand ore; b) transporting the loads of mined oil sand ore to a comminutor; c) comminuting the loads of mined oil sand ore; d) transporting the comminuted ore to a slurry apparatus; and, f) processing the comminuted ore with process solvent in the slurry apparatus to generate a bitumen-containing slurry; wherein a plurality of measurements at different component locations of the process line are obtained where one or more of steps (a) through (f) are performed, and wherein at least one component of the process line is locally controlled by a regulatory controller for that component to achieve a component target set-point for component based upon one or more of the plurality of measurements, and wherein the method further comprises a central controller: g) computing a calculated value based on at least one of the plurality of measurements; and, h) evaluating the calculated value with reference to a target value for the calculated value; and, i) applying an adjustment to an operating variable of a component to override the target set-point for the component, the adjustment based on the evaluation of the calculated value and the target value.

In an implementation of the above method, the method may further comprise displaying on a graphical user interface a representation of components of the process line, and further displaying a representation of a condition at least one component, the condition based on the calculated value and the target value.

In an implementation, a method is provided comprising: receiving a series of loads of mined oil sand containing bitumen into a system configured to process the loads of mined oil sand into a bitumen-containing slurry process stream output, wherein the system includes one or more operating constraints and wherein there are load fluctuations including variations in content and/or weight of each load and variations in duration of time between each load in the series; obtaining a measurement at a measurement location in the system; calculating a predicted value based on the measurement; and, based on the measurement, the predicted value and at least one operating constraint, adjusting an operating condition of the system, wherein the adjustment minimizes the impact of the load fluctuations on a characteristic of the bitumen-containing slurry process stream output.

In an implementation a method is provided for processing mined oil sand ore into a bitumen-containing slurry on a process line, comprising components of the process line performing the steps of: a) receiving loads of mined oil sand ore; b) transporting the loads of mined oil sand ore to a comminutor; c) comminuting the loads of mined oil sand ore; d) transporting the comminuted ore to a slurry apparatus; and, f) processing the comminuted ore with process solvent in the slurry apparatus to generate a bitumen-containing slurry; g) obtaining a plurality of measurements from different components of the process line where one or more of steps (a) through (f) are performed; h) based on the plurality of measurements, determining at least one calculated value; and, i) adjusting with a central controller a set-point of a component of the process line based on the at least one calculated value, wherein the adjustment is selected to optimise an overall performance metric of the process line as a whole and an adjusted set-point is different than the set point of the component selected to optimise a local performance metric of the component individually.

In an implementation a method is provided for operating a process line that processes a bitumen-containing ore into a bitumen-containing slurry, comprising: at least at one location, collecting a plurality of measurements from one or more sensors; computing at a central controller a calculated value based on at least one of the plurality of measurements; applying an adjustment to an operating variable of a component of the process line to override a target set-point of a regulatory controller for that component based on the calculated value and a target value for the calculated value.

In an implementation of the above method, the calculated value comprises a mass estimate of a surge pile; and, wherein the target value comprises a target mass of the surge pile; and, wherein the target set-point comprises a target feed rate of a feed conveyor transporting bitumen-containing ore from the surge pile to a slurry apparatus for creating the bitumen-containing slurry; and, wherein the adjustment comprises slowing the feed conveyor below the target feedrate until the mass estimate of the surge pile meets or exceeds the target mass of the surge pile. In an implementation, a system is provided for operating a slurry preparation process line for processing a bitumen-containing ore into a bitumen-containing slurry, comprising: at least one measurement sensor at a location of the process line adapted to collect a plurality of measurements; a central controller operative to compute a calculated value based on at least one of the plurality of measurements, and to apply an adjustment to an operating variable of a component of the process line to override a target setpoint of a regulatory controller for that component based on the calculated value and a target value for the calculated value.

### BRIEF DESCRIPTION OF THE DRAWINGS

In drawings which illustrate by way of example only,

FIG. 1 is a process flow diagram illustrating an example oil sands mining and processing operation.

FIG. 2 is a process flow diagram illustrating an example processing stage of FIG. 1

FIG. 3 is a chart illustrating an exemplar throughput plotted for a process line operated in a first condition and a second condition.

FIG. 4 is an embodiment of a graphical user interface.

FIG. 5 is an embodiment of a graphical user interface.

### DETAILED DESCRIPTION

In order to mine oil sand ore in a cost efficient manner, prior art methods have focussed on optimising individual processes through local automated process control. These prior art methods are directed towards optimising a throughput of an apparatus in an oil sand process line based upon conditions at that apparatus. One difficulty with this approach has been that measuring local conditions of an oil sand process line has proven to be difficult. Under the extreme conditions equipment is prone to breakage or inaccuracy. Furthermore, the variance in the ore condition between summer and winter has proven to complicate the direct measurement of ore characteristics on the process line.

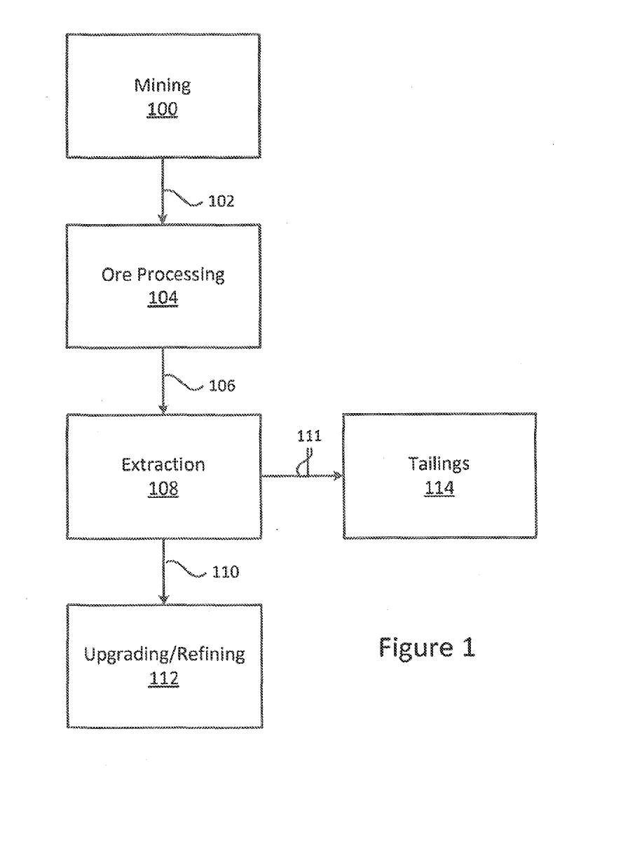

Referring to FIG. 1, a simplified process flow diagram illustrating oil sand mining operations is provided. The operations are broken down into individual stages for explanatory purposes, though in individual cases implementations of one stage may be preferentially performed in a preceding or following stage for practical considerations.

The first stage of the operation of FIG. 1 is mining 100 in which oil sand ore is mined from a mine site by excavation. The mined oil sand ore is conveyed 102 to ore processing 104. Current techniques for milling 100 and conveyance 102 of mined oil sand ore employ excavator shovels to mine the ore and deposit the mined ore in trucks. The trucks then convey 102 the mined ore to a crusher or comminutor to reduce the mined ore into a comminuted ore as an initial operation of the second stage of the operation, ore processing 104.

Ore processing 104 includes a series of operations to convert the mined oil sand ore into a pumpable oil sand shiny comprised of oil sand ore and process fluid. The pumpable oil sand slurry is conveyed by hydro-transport 106 to extraction 108. Conveniently, the hydro-transport 106 aids in “conditioning” the slurry.

Conventionally, the process fluid comprises process water that may be heated to a process temperature, and optionally the addition of one or more additives such as a diluent. Furthermore, the slurry may be further diluted with process fluids, or additional additives at later stages in the operations including in extraction 108.

The third stage of the operation of FIG. 1 is extraction 108 which includes operations to convert the pumpable oil sand slurry into a diluted bitumen product stream 110 and a tailings stream 111. Extraction 108 may further produce one or more recycled process fluid streams such as recycled process water or recycled diluent, which may be re-used within extraction 108 or directed to other operations such as processing 104.

The fourth stage of the operation in FIG. 1 represents all subsequent downstream processing of the diluted bitumen product stream 110 to produce various hydrocarbon products, which in this simplified schematic are referred to as upgrading and refining operations 112.

The fifth stage of the operation of FIG. 1 is tailings 114, which acts to dispose of the tailings stream 111, for example, in tailings settling ponds, though a variety of techniques may be employed depending upon the composition of the tailings stream 111.

A factor affecting the throughput of oil sand from mine site through to diluted bitumen product stream 110 is that ore processing 104 acts as an interface between the inconsistent operation of mining 100 and the continuous operations of extraction 108.

In general, the operations of extraction 108 are most efficient in relatively steady state operation with the composition of the input oil sand slurry stream in a relatively consistent state with smooth transitions between different compositions. Furthermore, extraction 108 requires a continuous input process stream, as the extraction operations have a relatively long start-up process before they are able to effectively separate and extract the bitumen, mineral solids and waste solvent efficiently. By contrast, mining 100 includes operations that are inherently on/off physical operations with individual shovels of varying ore-type being mined and conveyed in varying amounts and delivery timing to the comminutors of ore processing 104 that act to physically break down the mined oil sand ore. Due to the varying nature of each load of ore, as well as the varying timing between truck load deliveries, the comminutors may typically break down each deposited load at slightly different rates, resulting in sharp changes in the composition and rate of the comminuted oil sand ore in the first step of ore processing 104.

Generally, past methods have relied upon manual operator control, or local automated process control as described above, to locally adjust control set points of a single component of the process line in response to immediate changing conditions at that component. Typically, this local control is directed to optimise an operational speed or throughput of that particular component based upon the current operating conditions experienced by that component. Conventional thinking has been that by optimising each local component, the overall efficiency and throughput of an oil sands process line may be optimised. It has been determined, however, that optimising throughput of individual components may not lead to optimal throughput for the process line as a whole.

For instance, disruptions in delivery of mined oil sands loads may lead to an ore starvation condition at subsequent locations in the oil sands processing operations. Ore starvation, for instance, is typically accounted for in ore processing 104 by adding make-up process fluid at the final slurry stage to maintain a continuous flow rate through the hydro-transport 106 from ore processing 104 to extraction 108.

A downside of this conventional approach for accommodating mined oil sand ore delivery disruptions is that it leads to a higher consumption of process fluid and a reduction in the density of the oil sand slurry in hydro-transport 106 as the makeup process fluid replaces the missing ore. A further downside is that transitioning from full ore supply to no ore supply (“starvation”) results in step changes in loads on individual components of the process line, as well as step changes in the density of the oil sand slurry output from the slurry apparatus. Step changes are difficult for components to handle, leading to increased breakage frequency, as well as less efficient processing of both the oil sand ore and the oil sand slurry output. These changes further have a downstream effect on the efficiency of subsequent extraction processes, which are designed to optimally process an input oil sand slurry of a consistent target density, as opposed to a density that fluctuates around the target density.

The present system and method introduces one or more automated process controller(s) that operate to adjust the operations of various components in the process line to account for the variance in the loads and characteristics of mined oil sand being processed, as well as the operational state of components of the process line. In particular, the present system and method may act to apply an adjustment to one or more set-points, the adjustments determined to sacrifice a local performance metric of the process line in order to optimise an overall performance metric of the process line.

In an implementation, the present system and method generally acts to slow down individual components in the processing operation to allow more time to process heavier loads, and to speed up individual components under light load to ensure a consistent supply of processed oil sand ore to the slurry apparatus.

Where changes in supply are a necessity, e.g., ore starvation conditions, the systems and techniques described smooth out the transition from full ore supply to no ore supply, avoiding a step change from full operation to ore starvation. Smoothing out the transition can result in the following benefits. i) stretching out the transition may allow ore starvation events to be ‘worked through’ such that while the slurry apparatus may operate at an ore feed level below an optimised set-point for a period of time, the slurry apparatus does not transition to a “no-ore” condition where it is not receiving any oil sand ore; and, ii) in “no-ore” conditions, a density of the resulting oil sand slurry can taper from optimum density to 100% process fluid, rather than a step change in the slurry density. It has been determined that smoothing out the operations in this matter can reduce a number of ore starvation events, reduce consumption of process inputs such as process water, and increase a potential throughput capacity of the process line.

In an implementation, the controller is operative to receive one or more measurements as input to a process model, and to generate a calculated value. The calculated value may be an estimated value that estimates a current condition. Alternatively, the calculated value may be a predicted value that predicts a future condition. The controller then takes corrective action by adjusting a local operating condition based upon the calculated value. In an implementation the corrective action is taken to maintain a smoothly varying transition of at least one characteristic of an output from the system. The calculated value computed from the model may be an estimate of actual process measurements, conditions or states. The calculated value computed from the model may constitute a timer that predicts a time of a future state, such as a time for a hopper or surge pile to empty under current operating conditions.

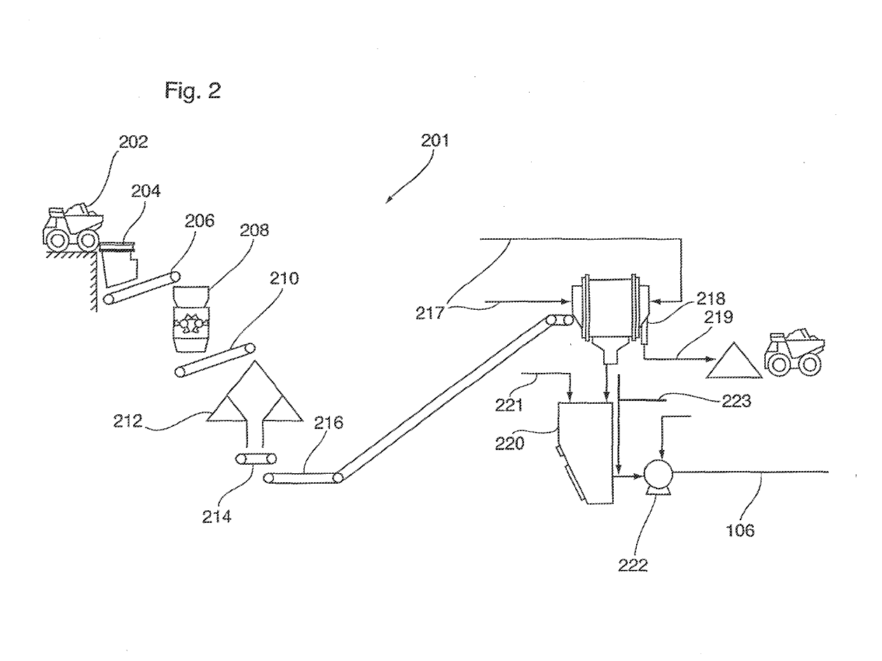

Referring to FIG. 2, an example embodiment of a process line 201 in ore processing 104 is illustrated. As will be appreciated, the exact lay-out and number of conveyors and processing equipment may vary from site to site. The embodiment of FIG. 2 is intended to provide an exemplary layout of a typical arrangement of equipment to process mined oil sand ore into an oil sand slurry for explanatory purposes. As will be appreciated by a person of skill in the art, some components recited below may be duplicated, modified or omitted depending upon the specific needs of an implementation.

In the example of FIG. 2, a truck 202 may be used to supply mined oil sand ore to a process line 201. A hopper 204 receives loads of mined oil sand ore and delivers it to a hopper apron feed conveyor 206 to convey the loads of mined oil sand ore to a comminutor 208, such as a roll crusher or other means known in the art. The hopper apron feed conveyor 206 is typically a variable speed conveyor to allow control over a rate of deposition of mined oil sand ore on the commmutor 208.

The comminutor 208 comminutes the received loads of mined oil sand ore into comminuted ore which may be deposited onto a comminuted ore feed conveyor 210. The comminuted ore feed conveyor 210 conveys the comminuted ore to an optional surge pile 212 that may retain a store of ore. The comminuted ore feed conveyor 210 is typically a constant velocity conveyor that provides a feed of comminuted ore to the surge pile 212 that may vary according to both the supply of ore from the hopper apron feed conveyor 206 to the commmutor 208, as well as the operation of the commmutor 208 on the supplied ore.

The surge pile 212 stores the comminuted ore to allow for constant delivery of ore to a downstream slurry apparatus 218, as well as to provide buffer capacity to ensure a steady supply of ore during periods of upstream downtime (e.g. shift change overs, excavator downtime, etc.).

The stored ore may be delivered from the surge pile 212 to a reclaim apron feed conveyor 214. The reclaim apron feed conveyor 214 is typically a variable speed conveyor that may convey the ore to a slurry apparatus feed conveyor 216. The slurry apparatus feed conveyor 216 is typically a constant velocity conveyor that supplies ore delivered from the reclaim apron feed conveyor 214 to a slurry apparatus 218, such as a rotary breaker. Delivery of the stored ore from the surge pile 212 to the slurry apparatus 218 is effectively controlled by the variable speed apron feed conveyor 214.

The slurry apparatus 218 receives ore from the slurry apparatus feed conveyor 216, and converts it into a slurry with the addition of process fluids 217. The slurry apparatus 218 may preferably provide a sizing operation to limit components of the slurry to a pre-determined maximum size, for instance 2″. The slurry apparatus 218 provides the slurry to a slurry pump box 220 that feeds oil sand slurry to hydro-transport pump 222. The slurry apparatus typically further includes oversize rejection 219 for diverting rejected rock and other mineral material that cannot be sized by the slurry apparatus 218. Oversize rejection 219 diverts the rejected material, typically to a reject pile, for temporary storage and then conveyance for disposal as backfill material. Hydro-transport pump 222 pumps the oil sand slurry through hydro-transport 106 to extraction 108.

The process line 201 may include other inputs such as process fluids 217 added to the slurry apparatus 218, process fluids 221 added to the slurry pump box 220, and process fluids 223 added at an outlet of the slurry pump box 220 to control a composition of the oil sand slurry conveyed by hydro-transport 106. Typical process fluids may include hot and/or cold process water, diluents, or other conditioning aids known in the art.

A conventional process line 201 may include a plurality of hoppers 204 for receiving mined oil sand ore from a train of trucks 202 at different locations at the mine site. A mine supervisor monitors a level of mined oil sand ore in each of the hoppers 204, typically by viewing an image of the ore level in each hopper 204 captured by video cameras located proximate to the hoppers 204.

The use of a plurality of hoppers 204 may be a preferred arrangement for increasing a mined ore throughput rate for the process line 201. By operating a plurality of hoppers 204 in parallel, the process line 201 may improve its accommodation of varied ore delivery scheduling from the trucks 202, as well as accommodating the downtime of any one hopper unit 204.

In an embodiment, the components of the process line 201 may be instrumented for local automation and control. For instance, instruments may include some or all of the following instrumentation.

Direct level sensor(s) may be provided on the hopper(s) 204 to detect a level of mined oil sand ore deposited into the hopper. Conventionally the level sensors have included video cameras to allow for an operator to estimate a level of oil sand ore in a hopper 204 based upon their remote view of the hopper 204, and laser sensors to directly measure a level of material in the hopper 204.

Load measurement sensor(s) may be provided to estimate a size of a load on the constant velocity conveyors including the comminuted ore feed conveyor 210 or the slurry apparatus feed conveyor 216. The load measurement may comprise, for instance, an amp reading of the motor(s) driving a constant velocity conveyor, or a weightometer to directly measure a weight on a portion of the conveyor such as a Ramsey™ Belt Scale.

Load measurement sensor(s) may be provided to detect a load on the motor(s) driving the comminutor 208, such as an amp reading of the motor(s).

Surge pile mass sensor(s) may be provided to detect a size/weight of the surge pile 212. In practice, however, it has been found that direct measurement of the size/weight of the surge pile 212 tends to be difficult, inconsistent and prone to inaccuracy. In an implementation, a system and method is provided to calculate an estimate of the mass of the surge pile without relying upon a direct measurement of a weight of the surge pile.

Temperature measurement sensor(s) may be provided to detect a temperature of the slurry exiting the slurry apparatus 218, or the oil sand slurry either in the slurry pump box 220, or at the supply to the hydro-transport pump 222. In practice, it has been found that direct measurement of the temperature of the slurry tends to be difficult, inconsistent and prone to inaccuracy. Furthermore, depending upon their location(s) the temperature sensor(s), such as thermocouples, may be prone to breakage if inserted into the slurry stream. In an implementation a system and method is provided to calculate an estimate of the slurry temperature, and to provide a correction factor(s) for correcting the temperature measurements made by the sensor(s).

Densometer measurement sensor(s) may be provided to detect a density of the slurry, or the oil sand slurry. Composition measurement sensor(s) may be provided to estimate a composition estimate of oil sand ore, slurry, or the oil sand slurry. In an embodiment: load measurement sensor(s) may be provided to detect a load on the motor(s) driving the slurry apparatus 218, such as an amp reading of the motor(s); Level sensor(s) on the slurry pump box 220 to detect a level of slurry in the slurry pump box 220; and load measurement sensor(s) to detect a load on the hydro-transport pump 220, such as an amp reading of the motor(s) driving the hydro-transport pump 220.

The instruments may provide for local automation and control of each component of the process line by local component regulatory controllers. The local component regulatory controllers can be operative to adjust one or more control variables based upon the instrument readings to optimise their local set-point.

For instance, the comminutor 208 may be controlled based upon a local supply of mined oil sand ore. Referring again to FIG. 2, the hopper 204 receives loads of mined oil sand ore and may be instrumented to indicate a current condition of the hopper 204. Level measurement sensor(s) on the hopper 204 (described below) may indicate: a full hopper 204 as a load of mined oil sand ore was recently deposited on the hopper 204; a partially full hopper 204 as a load of mined oil sand ore works its way through the hopper 204; or, an empty hopper 204 as the load has passed through the hopper 204 and a next load has yet to arrive. The instrument reading may be utilised to direct a next truck 202 to the hopper 204, for instance where a plurality of hoppers 204 are provided to receive loads of mined oil sand ore, or may be used to control a speed of the hopper apron feed conveyor 206.

In another exemplary implementation, densometer measurement sensor(s), and/or temperature measurement sensor(s), are provided in the slurry pump box 220 and monitored to control a supply of process fluid 221 to obtain a target density, and/or temperature, in the slurry pump box 220. Likewise, densometer measurement sensor(s), and/or temperature measurement sensor(s) are provided at an outlet of the slurry pump box 220 to monitor a density, and/or a temperature, of an oil sand slurry exiting the slurry pump box 220. Additional process fluid 223 may be added in response to the measurements to control the density, and/or temperature, of the oil sand slurry.

In a further exemplary implementation, load measurement sensor(s) are provided on the hopper apron feed conveyor 206, to detect a current load of mined oil sand ore to be transferred to the comminutor 208. Similarly, load measurement sensor(s) such as an amp reading of the motor(s) driving the comminutor 208, may be operative to detect a direct load on the comminutor 208. A combination of one or both of the above load sensors may be monitored to control a speed of the comminutor 210.

In an implementation, a level measurement sensor in the hopper 204 detects a current level of received ore. The level measurement sensor may include one or more pressure sensors on a wall of the hopper 204, and a level of ore in the hopper 204 inferred from the one or more pressure sensors detecting ore pressing against the one or more sensors. In an implementation, a hopper apron feed conveyor load measurement of a motor driving the hopper apron feed conveyor 206 is provided to detect a current amount of received ore on the hopper apron feed conveyor. In an implementation, a comminutor load measurement sensor of a motor driving the comminutor 208 may be provided to detect a current load on the comminutor 208, which may be inferred as providing an estimate of an amount of ore feed being currently processed by the comminutor 208.

In an implementation, a regulatory controller is provided to slow a nominal speed of the hopper apron feed conveyor 206 when the level measurement indicates the hopper 204 is empty.

In an implementation, a load measurement sensor on the hopper apron feed conveyor 206 is an ampere meter monitoring a draw of current by a motor driving the hopper apron feed conveyor 206. A regulatory controller may detect a spike in the ampere measurement and infer that a relative oversized lump of ore is on the hopper apron feed conveyor 206. In response, the motor speed can be adjusted to slow the hopper apron feed conveyor 206 when the identified lump is delivered to the comminutor 208, slowing delivery of additional ore to allow time for the comminutor 208 to work through the identified lump. That is, the apron feed conveyor motor speed may be adjusted to supply a relatively steady supply of received ore to the comminutor 208 based upon the load measurement.

In an implementation, a current amount of received ore at a time step is recorded and a current hopper apron feed conveyor speed is used to estimate when the current amount of received ore at the time step will reach an end of the hopper apron feed conveyor 206 to comprise delivered ore. The current hopper apron feed conveyor speed can be adjusted based upon the current amount of received ore corresponding to the delivered ore.

In an implementation, a current comminutor load is measured and the hopper apron feed conveyor motor speed is adjusted to deliver less ore when the comminutor 208 is under heavy load and to supply more ore when the comminutor 208 is under light load.

In an implementation, a plurality of comminutors 208 are provided to comminute loads of mined oil sand ore. Each of the plurality of comminutors 208 are provided with at least one measurement sensor of its own that is monitored to provide an estimate of an availability of that comminutor 208. A next load of mined oil sand ore is directed to each of the plurality of comminutors 208 based upon their availability.

In an embodiment, at least one central controller is provided to receive measurements from a plurality of measurement sensors located at different locations of the process line 201. The plurality of measurement sensors may comprise some or all of the instruments described above, or may include additional sensors, for instance between component sensors. In the present description, where reference is made to a central controller, it is understood that functions may be divided across more than one central controller depending upon a specific implementation.

In an implementation, the at least one central controller is in a master-slave relationship with one or more local component regulatory controllers on the process line 201. The one or more local component regulatory controllers being operative to adjust process inputs and control set-points to maintain optimum operational condition(s) of each component, for instance to meet a pre-determined local output target, based upon one or more input variables, within pre-specified operational limits, typically at the local component level. The local regulatory controller being operative to receive current measurements as the one or more input variables, and to adjust one or more process inputs in response to the received current measurements to optimise the local operational conditions measured by the one or more input variables. The local regulatory controller being considered “local” as it optimises operation of a component based upon current local conditions.

The at least one central controller, master, may apply a control adjustment to override a local component regulatory controller, slave, to adjust process inputs and control set-points of the component in order to optimise overall operation of the process line 201, as measured by an overall performance metric of the process line, such as process line tonnage throughput. The override may necessarily sacrifice optimisation of the local output target, leading to underperformance with respect to a local performance metric. In an implementation, the controller may be operative to by-pass the local regulatory controller(s) and adjust a local process input or control set-point directly. The central controller may execute to update its process-wide model regularly, such as every second.

In an implementation, a system comprised of a combination of automated components of a process line 201, controlled by one or more central controllers, may be provided. The components and central controller(s) may be operative to act in concert to adapt to changing ore input conditions, to provide more consistent delivery of processed oil sand ore to a slurry apparatus 218, and to provide a more consistent delivery of oil sand slurry to hydro-transport 106. For instance, in an implementation the central controller slows a conveyor to nominal speed in reaction to a calculated value, rather than in response to a measured value. Where more than one central controller is provided, each central controller is preferably responsible for an independent operational state of the process line.

In an implementation a first central controller is provided for handling the “dry” end of the ore processing operations, and a second central controller is provided for handling the “wet” end of the ore processing operations. The first central controller being operative to manage its portion of the process line to receive intermittent delivery of mined oil sand ore and to transition to a continuous feed of comminuted ore. The second central controller being operative to receive comminuted ore and to manage its portion of the process line to deliver a slurry of smoothly varying density to a hydro-transport line.

In an implementation, a system and method is provided for operating an oil sand ore process line 201. The system and method manages the throughput of oil sand ore during processing to smooth throughput and manage process inputs.

In an implementation, the system and method may employ a dynamic predictive model-based process control to adjust process control variables on the process line 201 in response to a change in a measured, calculated or predicted condition of the process stream at particular locations along the process line 201. The system and method may calculate or predict an availability status of one or more components of the process line 201, and adjust one or more local process set-points in response to the calculated or predicted availability, to effect smooth transitions in local process conditions throughput the process line 201.

In an implementation, the central controller may implement inferential modelling to estimate properties for use as one or more calculated values at locations along the process line 201 for which a direct measurement is unavailable, inaccurate or undesirable.

The calculated values may act as inputs to an advanced process control model for the process line 201. In an implementation the one or more calculated values may comprise a mass measurement, or a predicted future mass measurement, of ore at a location in the process line 201 for which a direct measurement is unavailable, inaccurate or undesirable. In an aspect, the location may be a surge pile containing comminuted ore.

The estimated property may be presented as a measurement provided by a “soft sensor”, a calculated value to be used by a central controller or a regulatory controller in place of an actual measurement value provided by a measurement sensor.

For example, directly measuring a weight of ore stored in a surge pile may not be practical, or result in an inaccurate value. The central controller may estimate the weight of the ore stored in the surge pile by measuring the mass of the ore input to the surge pile, and subtracting the mass output from the surge pile and performing a mass balance calculation to derive a mass estimate for the surge pile. By continuously updating the mass balance calculation, the current mass estimate of the surge pile may be presented as being measured by the soft sensor, though no direct measurement of the surge pile has taken place.

In an implementation, the soft sensor may provide a hybrid of multiple calculated values. For instance, a direct measurement may be combined with a calculated estimate to provide improved accuracy. For instance, a height of the surge pile may be measured by a laser or a camera, and a volume of ore estimated based upon the height measurement and a physical model for a shape of the surge pile. The estimated volume of ore may be used to produce a measured mass estimate for the surge pile. The measured mass estimate may be compared with the mass estimate derived from the mass balance calculation to apply a corrective factor. Accordingly, a near real-time measured mass estimate may be provided from the height measurement, as continuously corrected by the mass estimate derived from the mass balance calculation.

In an implementation, the central controller may be operative to take as input measurements taken by one or more measurement sensors located between components of the process line to provide additional measurement information for the model.

In an implementation, the central controller may implement timer-based model calculations to predict a future condition, such as a potential ore starvation event, in real-time. In an implementation the central controller may inform a control room operator through a graphical user interface of the predicted future condition.

In an implementation, the central controller may slow a feed rate at a component below an optimum locally-available target feed rate at times of heavy oil sand ore delivery based on a measured value or an estimated value, or in anticipation of an ore starvation event based on a predicted value, to provide a steady, smoothly varying supply of processed oil sand ore throughout the process line 201. In an implementation, the central controller may accelerate a feed rate where estimated conditions, or when predicted future conditions, remain within operational constraints. The central controller may accelerate the feed rate, for instance, when a calculated mass measurement indicates a component is being under-utilized, and is available to receive more ore than is currently being supplied.

In an embodiment, the central controller may input the measurement samples to a model. The model being a mathematical model of the physical steps of the process line 201 taken to process mined oil sand ore into an oil sand slurry, that is updated in real-time, or near real-time, by the central controller. Conditions of components and oil sand feed at various locations of the process line 201 may be represented by variables in the model, or may be determined by evaluating a calculated value with reference to a target value.

The controller may use the model to predict a likely future state (the “predicted state”) of the process line based on the measurement samples, and apply a correction by overriding one or more local set-points when the predicted state deviates from a target state. A decision to override the one or more local target set-points may be likewise determined by evaluating the calculated value with reference to the target value. In particular, the central controller may apply the correction to change a local feed rate to avoid a predicted future ore starvation condition. The correction is applied to override decisions made by a local regulatory controller that relies upon current measurement samples to meet a target set-point for a component.

Accordingly, the central controller may provide a continuous process of measurement sampling, analysis, prediction and correction to smooth an operational state of the process line 201, by overriding the local regulatory controller that relies upon direct measurement of current process line conditions. In an implementation, the central controller may be further operative to effect action to keep one or more of the measurements from violating process or alarm limits in the future.

In an implementation, the at least one central controller may be operative to optimise one or more states of an output product from the process line 201. In an implementation, the output product may comprise oil sand slurry and the states may comprise at least one of: density of the oil sand slurry; temperature of the oil sand slurry; or, another physical characteristic of the oil sand shiny. For example, the controller may be operative to control a variance in one or more states of the output product from the process line 201. Controlling a variance can include adjusting feed rates of one or more components of the process line 201 to maintain a smoothly varying physical characteristic of the output product. In an example, the output product is oil sand slurry and the physical characteristic is density and/or temperature of the oil sand slurry. The control may comprise adjusting the flow of an input, such as hot process water, or comminuted oil sand, to maintain the smoothly varying physical characteristic.

In an implementation, the controller may be operative to adjust feed rates of one or more components of the process line 201 to maintain a smoothly varying mass transfer of oil sand within the process line 201. For example, the controller may be operative to accelerate or slow feed rates of one or more components of the process line 201 to provide a smoothly varying supply of oil sand ore to adjacent components. Maintaining a smoothly varying mass transfer can avoid an ore starvation condition at one or more of the components of the process line. Avoiding an ore starvation condition is desirable as ore starvation can lead to abrupt changes in local process conditions which may damage equipment. Furthermore, re-supplying ore after an ore starvation event may require a “ramp-up” time where some or all of the components operate at sub-optimal rates to build up to an optimum operational condition, which can therefore be avoided.

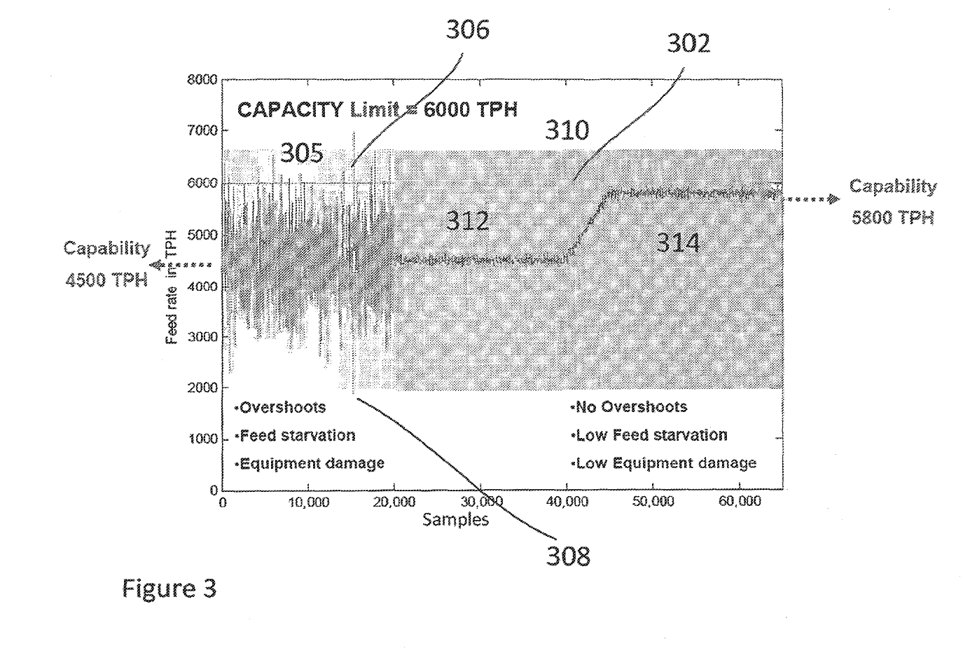

Referring to the plot of FIG. 3, an experimental throughput of an oil sand process line is demonstrated for two conditions 305, 310. The plot illustrates tons per hour of feed rate on the y-axis, and samples over a period of time on the x-axis. Overall, the plot shows the variance in feed rate over a sampled time period.

In the first condition 305, the feed rate is highly varied, as equipment shifts between optimal operation and sub-optimal operation. The throughput includes overshoot conditions 306 where throughput is above the desired target throughput 302 for short periods of time, and undershoots 308 where some or all of the process line is experiencing ore starvation conditions and the throughput is well below the target throughput. Overshoots 306 are undesirable as they can lead to premature wear or breakage of parts. Undershoots 308 are undesirable as they indicate the process line is operating with poor efficiency. An example resultant average throughput capacity for the first condition of the process line is indicated at about 4500 tonnes per hour (TPH).

In the second condition 310, the feed rate varies less. Accordingly, for the same average throughput, the variances stay well below the target throughput 302, as shown in condition 312. As a result, the average throughput may actually be increased without risk of damaging components of the process line 201, as shown in condition 314. As indicated in FIG. 3, an example average throughput capacity for condition 314 of 5800 TPH is higher than the average throughput capacity for the first condition. While the average throughput in condition 314 is above the average throughput in condition 305, there are less instances of overshoot, none in the example. It will be appreciated that the average throughput amounts listed are for illustrative and relative comparison purposes, and the actual amounts are not intended as anything more than examples. It will be appreciated that the actual capacity throughput limit and realised throughputs would vary given a particular process line 201.

Accordingly, although the at least one central controller may be operative to slow feed rates of one or more components below an optimum set point maintained by a regulatory controller for that component, by smoothing an operational state of the process line 201 a higher throughput capacity for the whole process line 201 may be achieved. It has similarly been found that consumption of process inputs such as process fluids and power, may be reduced by smoothing the operational state of the process line 201.

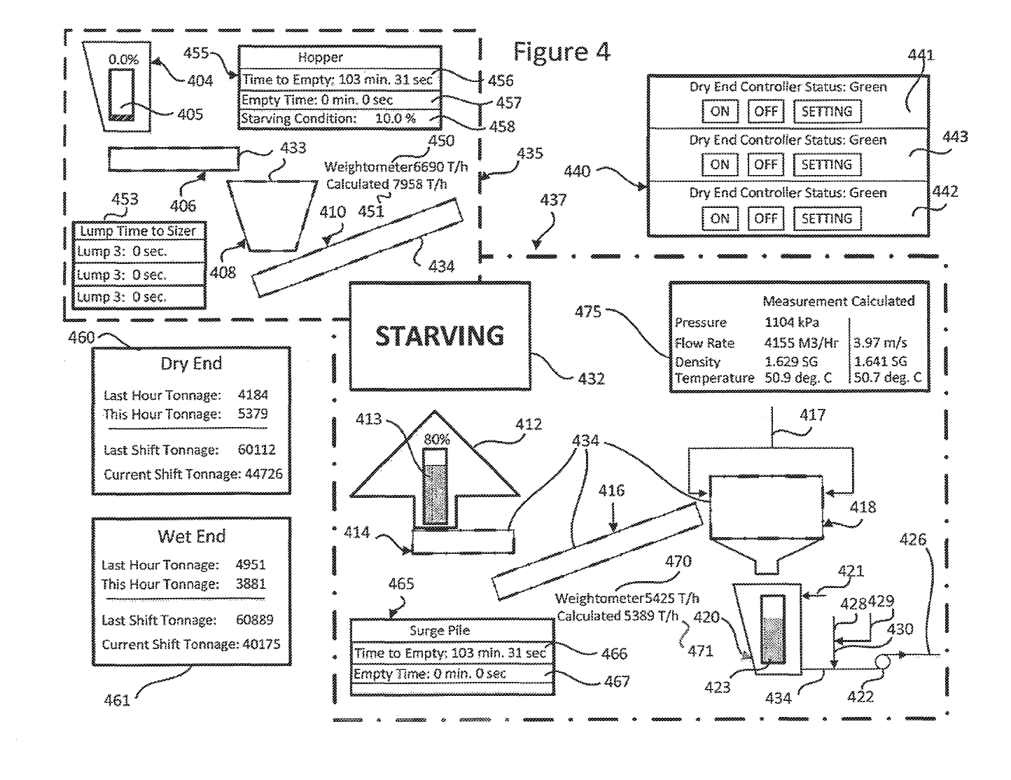

Referring to FIG. 4, in an implementation, a graphical user interface representative of steps or stages in the process line may be provided for use by an ore processing control operator. The ore processing control operator has control over operations in ore processing 104, from the receipt of mined ore conveyed by mining 100, to delivery of oil sand slurry for hydro-transport 106. A representation of a condition of each step may be overlaid on the graphical user interface.

As illustrated the representations may include, for instance, a hopper 404, hopper apron feed conveyor 406, comminutor 408, comminuted ore feed conveyor 410, surge pile 412, reclaim apron feed conveyor 414, slurry apparatus feed conveyor 416, slurry apparatus 418, process fluid inputs 417, 421, 430, slurry pump box 420, hydro-transport pump(s) 422, and hydro-transport pipe 426. As illustrated, process fluid input 430 may comprise a combination of hot process fluid 429 and cold process fluid 428.

The user interface may further include component outlines that may be highlighted different colours to indicate a status of each component. In the example of FIG. 4, a “STARVING” condition is indicated in a display region 432. The process line 201 is broken up into two sections in FIG. 4, a “dry end” 435 and a “wet end” 437. The separation is convenient as the surge pile 412, which acts as a buffer, may independently receive and deliver comminuted ore at different rates. In the example, the dry end 435 is surrounded by a coloured outline 433, as well as the hopper apron feed conveyor 406 and comminutor 408 to indicate an ore starvation condition at that location in the process line. For instance, the dry end 435, hopper apron feed conveyor 406 and comminutor 408 may be illustrated with an orange outline. The comminutor 404 is illustrated with a hopper level gauge 405 that, in the figure, is illustrated as being empty. For instance, the hopper level gauge 405 may include a coloured highlight to indicate no ore on the hopper level gauge 405, such as a red highlight. The comminuted ore feed conveyor 410 may still be conveying leftover comminuted ore to the surge pile 412, and accordingly it may either be similarly highlighted to indicate an ore starvation condition, or may be highlighted a different colour, for instance blue, to indicate it is still conveying ore. Accordingly, the dry end 435 is highlighted as being under an ore starvation condition in that stage, and each component of the dry end includes an independent outline to identify a current state of that component.

In FIG. 4, the wet end 437 is illustrated with an outline highlighted to indicate a “NORMAL” condition, for instance a blue outline. The surge pile 412 includes a surge pile level gauge 413 that indicates the surge pile 412 is well supplied with ore. For instance, the surge pile level gauge 413 may include a coloured highlight to indicate a supply of ore on the surge pile level gauge 413, such as a blue highlight. In an implementation, the highlight colour of the surge pile level gauge 413 may differ from the outline highlight, for instance a lighter shade of blue.

Since the surge pile 412 is able to supply comminuted ore, the reclaim apron feed conveyor 414, slurry apparatus feed conveyor 416, slurry apparatus 418, hydro-transport pump(s) 422, and hydro-transport pipe 426 are similarly illustrated with an outline to indicate a “NORMAL” condition. The slurry pump box 420 includes a slurry pump box level gauge 421 that indicates the level in the slurry pump box 420. For instance, the slurry pump box level gauge 421 may include a coloured highlight to indicate a supply of ore on the slurry pump box level gauge 421, such as a blue highlight.

The user interface of FIG. 4 further includes a central controller status 440 of three central controllers, the dry end controller status 441, the wet end controller status 442 and the breaker and hydro-transport controller status 443. As will be appreciated, the three central controllers could be implemented as a single controller.

In an implementation, the central controller may compute an estimated condition that may comprise a real-time calculated oil sand ore mass value for one or more locations on the process line 201. The real-time calculated oil sand ore mass value may be calculated based upon mass measurements collected from one or more mass measurement sensors on the process line 201, and one or more conveyor velocity measurements, as modified by a model. The mass value may be calculated, for instance, as a mass balance computed based upon an estimated mass inflow and an estimated mass outflow from a component. For example, in an implementation, the model may use the calculated mass value to apply a correction factor to adjust a direct mass measurement reading supplied by a mass sensor, such as a weightometer, located at the component. In this manner, the model may provide a calculated mass value at that sensor location by applying the correction factor to the mass measurements provided by that sensor, the calculated mass value being more accurate than the direct reading supplied by that mass sensor without the correction factor. As was mentioned above, in an implementation the calculated mass value may be determined for a location other than that sensor location as necessary.

In an implementation, an estimated condition of at least one component of the process line 201 may be calculated by the central controller, and may be estimated by the model from measurements collected from one or more of the plurality of measurement sensors. The user interface of FIG. 4 indicates a number of calculated and predicted values estimated by the central controller, in addition to measured values directly measured by sensors.

For instance, an estimate of comminuted ore throughput at the comminuted ore feed conveyor 210 is illustrated as a measured value 450, for instance a reading or average of readings from a weightometer on the comminuted ore feed conveyor 210, and an estimated mass flow value 451 (F) calculated by the wet end controller. The estimated value 451 may be calculated based upon a velocity of the comminuted ore feed conveyor 210 S, the weightometer reading W, and a number of tunable coefficients including a numerator coefficient k₁, weightometer coefficient k₂, a mass flowrate coefficient k₃, a denominator coefficient k₄, and a speed coefficient k₅.

$$F = \frac{{k}_{1} + {k}_{2} \cdot W + {k}_{3} \cdot W \cdot S}{{k}_{4} + {k}_{s} \cdot S}$$

In some implementations, the coefficients are empirically derived for a specific installation. An operator using the interface has the option between using the measured value 450 and the estimated value 451. Similar to the estimate of comminuted ore throughput, an estimate of stored ore throughput on the slurry apparatus feed conveyor 216 is provided based upon a measured value 470 and an estimated value 471 calculated in a similar fashion.

A condition of the hopper apron feed conveyor 206 is indicated as a time for lumps to reach the sizer indicator 453. The lumps being identified by monitoring a motor load of the hopper apron feed conveyor 206 and a speed of the hopper apron feed conveyor 206. A detected increase in motor load with no corresponding increase in conveyor speed is a trigger identifying the arrival of a lump on the hopper apron feed conveyor 206. The time to reach the sizer, comminutor 208, is calculated based upon the known length of the hopper apron feed conveyor 206, the time the lump was detected arriving on the receiving end of the hopper apron feed conveyor 206, and the speed of the hopper apron feed conveyor 206. Feedback regarding a time for lumps on the hopper apron feed conveyor 206 to reach a sizer, comminutor 208, may be used by the controller to adjust a velocity set-point of the hopper apron feed conveyor 206, or used by a mine site operator to re-direct trucks 202 to an alternate hopper 204 in anticipation of an elevated time to empty hopper 204. In an implementation, the controller can re-direct the trucks 202 directly, without operator intervention.

A condition of the hopper 204 is indicated 455 as an estimated hopper time to empty 456, a duration the hopper has been empty 457, and a “starving condition” of the current hopper level 458. The three indications may be used by an operator to identify which hopper 204 will empty first, and when. This allows for re-allocation of trucks if necessary. It also provides for an indication of a potential future drop in ore throughput to surge pile 212.

A condition of the surge pile 212 may be indicated 465 as a surge pile time to empty indication 466 and a surge pile empty time 467. The surge pile weight may be estimated based upon a mass balance by integrating a mass balance between the mass throughput calculated being deposited from the comminuted ore feed conveyor 210 to the surge pile, and the mass throughput calculated being conveyed away by the slurry apparatus feed conveyor 216.

The surge pile weight may also be estimated based upon a direct measurement of a current height of the surge pile 212, for instance using a laser. The mass may be computed based upon a pre-determined geometry estimate for the surge pile 212, as modified by the current height.

Finally, the surge pile weight may comprise an override set-point specified by an operator, for instance when there is no ore in the pile.

The final weight value used by the controller(s) may comprise one of the above, or a combination. Furthermore, each of the two calculated values and the operator override value may be used to correct one of the calculated values.

The surge pile time to empty may be calculated based upon the estimated weight value of the surge pile 212, divided by the current mass throughput being conveyed away by the slurry apparatus feed conveyor 216. In this implementation, the time to empty represents how long current ore processing operations may continue if infeed of comminuted ore to the surge pile 212 were to stop. In an implementation, the surge pile time to empty may be calculated based upon the estimated weight value of the surge pile 212, divided by the difference between the current mass throughput being deposited on the surge pile, and the current mass throughput being conveyed away by the slurry apparatus feed conveyor 216. In an implementation, some or all of the above throughputs may be calculated as moving averages, for instance, the average throughput over the last X minutes.

General dry end performance metrics 460 and wet end performance metrics 461 are also provided, tracking throughput amounts either measured or estimated by the controllers.

A dump condition indicator 459 is provided to highlight a status of the dump condition currently indicated by the ore processing operator. As a result of a shut down condition, the ore processing operator may override commands given by the mine plan operator to indicate to the trucks 202 not to dump ore in the hopper 204, for instance.

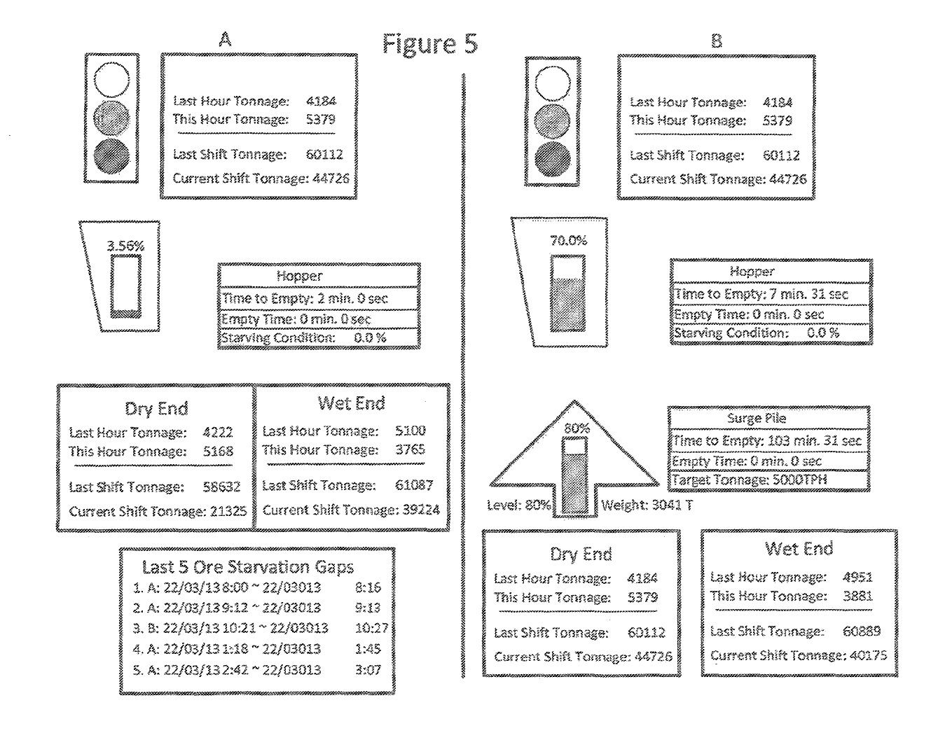

Referring to FIG. 5, in an implementation, a graphical user interface representative of steps or stages in the process line may be provided for use by mine dispatch operator. The mine dispatch operator has control over operations in mining 100, from the excavation of oil sand ore, deposition of the excavated ore on trucks for conveyance and delivery to ore processing 104. A representation of a condition of each step may be overlaid on the graphical user interface.

In the example of FIG. 5, two process lines 201 are indicated. Process line A is shown without a surge pile 212, and process line B is shown with a surge pile 212. FIG. 5 provides a graphical interface displaying calculated and estimated information computed by the at least one central controller(s) of ore processing 104.

The use of the graphical interface allows for shifting the optimisation of mining 100 from local optimisation to plant level optimisation. For instance, key performance metrics for milling 100 can be to maximise the:

hours of use of each active truck 202 and driver; and,

tonnage throughput from shovel to hopper 204.

At the start of each day, mining 100 can plan a number of active trucks 202 and a number of active drivers for each shift to drive the trucks to achieve a target throughput of mined ore to the hopper(s) 204. The goal for mining 100 is to ensure all active trucks 202 are either receiving ore from an excavator, conveying ore to a dump point, or dumping ore at a dump point.

At the plant level, ore processing 104 is optimised when it receives regular ore delivery that may be directed at individual times to a specific hopper based upon current downstream needs. Optimising ore processing 104, however, may lead to a sub-optimal local optimisation of mining 100. A difficulty is to provide milling with new key performance metrics that change its behaviour to optimise at the plant level.

The graphical user interface of FIG. 5 addresses this need by providing target tonnage metrics for deposition at the hopper(s) 204, time to empty and empty time at each hopper 204 and surge pile 212, as well as an indication of the last 5 ore starvation gaps in ore processing, along with their date, time and duration. In the implementation shown, an indication of which train (A or B) experienced the starvation is also provided. Inclusion of the last 5 ore starvation gaps downstream from milling 100 provides a new key performance index that may be used by mining 100 to optimise their operations at the plant level, rather than at a local level. Although the last 5 ore starvation gaps are shown, it should be understood that in other implementations more or fewer ore starvation gaps can be provided.

The graphical user interface of FIG. 5 further includes the dump condition indicator 459 controllable by ore processing 104 to effectively override the instructions of mining 100 to the trucks 202.

In an implementation, the model may estimate a real-time mass value for a location on the process line that does not have a corresponding sensor, or that has an unreliable sensor. The estimated real-time mass value may be used as an input to a process model that is operative to control a component at that location. The model may further apply correction factors to the calculated value by cross-referencing calculated values with corresponding measurements or calculated values based on different inputs.

In an implementation, the model may combine mass measurements sampled at different sample times, to calculate local mass values at different locations and/or sample times. Each calculated local mass value corresponds to a sample of oil sand ore at a location along the process line at a point in time. The calculated local mass values may be used to cross-correlate to physical measurements of the mass of the sample taken by mass measurement sensors situated along the process line, to calculate a correction factor for each mass measurement sensor. Accordingly, a controller may effect a real-time correction to one or more sensor readings based upon the correction factor.

In an implementation, a measurement may be taken at a downstream facility, such as extraction 108, and input to the model to apply a correction to sensor readings and calculated values determined by the model. For instance, a density of oil sand slurry received by extraction 108 may be compared to a density of oil sand slurry output from the slurry pump box 220. Based on the comparison, the controller may apply a correction factor to readings obtained from the densometer located at the slurry pump box outlet. A similar correction factor may be applied to the calculated mass value.

In an implementation, the correction may be applied by the model to measurements collected from measurement sensors to apply cross-confirmation on different time scales. By way of example, a mass measurement sensor(s) on an external ore handling component, such as hopper apron feed conveyor 206 may be susceptible to drifts in reading accuracy on a short time scale (days-weeks). The controller may be operative to compute and apply a correction factor based upon one more mass measurement sensors, such as a current densometer reading at the slurry pump box outlet 220 and an average mass throughput calculated from the surge pile mass measurement. The correction factor may be determined, for instance, by comparing a sample of mass measurements at the hopper apron feed conveyor 206 with a corresponding sample or average of samples of a densometer reading at the slurry pump box outlet 220.

Accordingly, a corresponding sample of a densometer reading is “time-shifted” relative to a time of the sample of the mass measurement at the slurry apparatus feed conveyor 216 to account for a period of time for a sample of oil sand ore processed by the slurry apparatus feed conveyor 216 to travel through the process line 201 to arrive at the slurry pump box outlet 220. The correction factor may be further determined by comparing an average of samples of mass measurements at the slurry apparatus feed conveyor 216 with the average mass throughput calculated from the surge pile mass measurement. In an implementation, the correction factor may be calculated by a combination of the above methods. In an implementation, the correction factor may be calculated from a running average of measurements or calculated values over a time period.

In an implementation, the corrected mass measurement sensor(s) may be used to assist in validating a sensor that may be susceptible to drifts in reading accuracy on a longer time scale (weeks-months). Accordingly, the corrected mass measurement sensor described above may be used to calibrate, or confirm the calibration, of the sensor susceptible to drifts in reading accuracy on the longer time scale.

In an implementation, the graphical user interface may be operative to display a running average of measurements or calculated values sampled over a time period. The graphical user interface may further be operative to display one or more predicted conditions based upon an output from the model. The graphical user interface may further be operative to display a prompt that requests action from a control room operator, and to receive confirmation from the operator to override a regulatory controller(s) to correct an operational state in reaction to the one or more predicted conditions.

Accordingly, a local control set-point may be overridden to a new sub-optimal set-point in order to account for conditions measured at an upstream or downstream location from the local control-point location. The decision to override the local control set-point may be taken responsive to a predicted future measurement calculated based upon a measurement taken at the upstream or downstream location. Implementation of the decision may be automated, manual requiring operator intervention, or a combination.

In an implementation, the graphical user interface may be operative to display at least one throughput metric calculated by the controller from at least one mass measurement sampled from the process line 201. In an implementation, the throughput metric may comprise a calculated mass value, or average of calculated mass values over a time period.

In an implementation, the graphical user interface may be operative to display one or more alarm condition states in response to at least one of: a measurement, a calculated value, or a predicted value.

In an implementation the graphical user interface may be operative to display information at locations proximate to representations corresponding to components of the process line 201. The displayed information may comprise real-time information sampled from a sensor at that location, a calculated value corresponding to that location as determined by the model, or a predicted value as determined by the model. In an implementation the calculated or predicted value may comprise one or more estimates of current ore supply the location.

In an implementation, the calculated or predicted value may comprise a run-time value for that component based upon measured, calculated or predicted mass values within the process line 201. In an implementation, the graphical user interface may be operative to display an indicator corresponding to the run-time for that component. For example, the indicator may comprise a colour of the component on the graphical user interface, and the colour may change when the run-time or predicted mass value passes a pre-determined threshold. The graphical user interface can be operative to display varying alarm level conditions corresponding to levels of run-time or predicted mass value to alert a control room operator of a potential future ore starvation event. The graphical user interface can be operative to propose remedial actions to the control room operator, such as accelerating or slowing a speed of a conveyor, or re-directing a truck dumping location, to remediate an alarm condition.

The processes in extraction 108 and upgrading and refining 112 are generally continuous operations. For instance, extraction 108 is typically structured to receive a continuous inflow of pumpable oil sand slurry through hydro-transport 106 and output a continuous outflow of diluted bitumen product stream 110 to upgrading and refining 112.

Conversely, the process of physically excavating oil sand ore in mining 100 is a binary-type start-stop operation. The subsequent conveying, comminuting and processing steps are intended to run continuously, but due to variance of ore and the limitations of physically processing an oil sand ore, may run at varied speeds or cease operating intermittently. These varied processes interface with hydro-transport 106, which is preferably run in continuous fashion with make-up process fluid (typically hot process water) added as necessary to maintain volume flows.

Various embodiments of the present invention having been thus described in detail by way of example, it will be apparent to those skilled in the art that variations and modifications may be made without departing from the invention. The invention includes all such variations and modifications as fall within the scope of the appended claims.

1. A method of operating a slurry preparation process line for processing a bitumen-containing ore into a bitumen-containing slurry, comprising:
at least at one location of the process line, collecting a plurality of measurements from one or more sensors;
computing at a central controller a calculated value based on at least one of the plurality of measurements;
applying an adjustment to an operating variable of a component of the process line to override a target setpoint of a regulatory controller for that component based on the calculated value and a target value for the calculated value.

2. The method of claim 1 wherein the adjustment comprises applying a correction factor to sensor measurements input to the regulatory controller.

3. The method of claim 2 wherein the calculated value comprises a mass estimate of a surge pile; and, wherein the target value comprises a target mass of the surge pile; and, wherein the target setpoint comprises a target feed rate of a feed conveyor transporting bitumen containing ore from the surge pile to a slurry apparatus for creating the bitumen-containing slurry; and, wherein the adjustment comprises slowing the feed conveyor below the target feedrate until the mass estimate of the surge pile meets or exceeds the target mass of the surge pile.

4. The method of claim 1 wherein components of the process line perform the steps of:
a) receiving loads of mined oil sand ore;
b) transporting the loads of mined oil sand ore to a comminutor;
c) comminuting the loads of mined oil sand ore;
d) transporting the comminuted ore to a slurry apparatus; and,
f) processing the comminuted ore with process solvent in the slurry apparatus to generate a bitumen-containing slurry;
wherein the plurality of measurements are obtained at different component locations of the process line where one or more of steps (a) through (f) are performed.

5. The method of claim 4 wherein the comminuted ore is transported to the slurry apparatus by, after comminuting the loads of mined oil sand ore, transporting the comminuted ore to a surge pile, and dispensing the comminuted ore from the surge pile for transport to the slurry apparatus; and, wherein the calculated value comprises at least one of: a mass estimate of the comminuted ore currently in the surge pile, or an estimated time to empty the surge pile, and the target value comprises a corresponding at least one of a minimum mass value, or a minimum time to empty for the surge pile.

6. The method of claim 1 further comprising displaying on a graphical user interface a representation of components of the process line, and further displaying a representation of a condition at least one component, the condition based on the calculated value and the target value.

7. The method of claim 1 further comprising displaying on a graphical interface a representation of components of the process line, wherein the calculated value comprises at least one throughput metric calculated for at least one component, and wherein the method further comprises displaying the at least one throughput metric on the graphical user interface at a location corresponding to that component.

8. The method of claim 6 wherein the condition is an alarm condition corresponding to that component, the method further comprising highlighting the representation of that component.

9. The method of claim 8 further comprising displaying a proposed remedial action to the alarm condition.

10. The method of claim 1 wherein the central controller is operative to input the plurality of measurements to a model, the central controller using the model to generate the calculated value based on the plurality of measurements.

11. The method of claim 10 wherein the calculated value comprises a predicted value corresponding to a predicted future operational condition.

12. The method of claim 8 wherein the predicted value comprises a predicted state of at least one component and the target value comprises a target state for the component,
wherein when the predicted state deviates from the target state, the adjustment is applied to minimize a difference between the predicted state and the target state.

13. The method of claim 12 wherein the predicted state comprises a predicted future time to empty for an ore supply and the target state comprises a minimum target time, and wherein the adjustment comprises overriding an operational set-point of the regulatory controller to reduce a conveyor feed speed until the predicted future time to empty meets the minimum target time.

14. The method of claim 12 wherein the central controller operates continuously to predict states and apply corrections to maintain a slow variance operational state of the process line.

15. The method of claim 14 wherein the central controller is further operative to monitor a predicted variance of the operational state and to increase component process rates when a predicted future variance is below a threshold limit.

16. The method of any one of claim 6, wherein real time information of at least one of the plurality of measurements, the model, an estimated value, and a predicted value are displayed on the graphical user interface.

17. The method of claim 6, wherein the calculated value comprises a mass estimate of available comminuted ore and the target value comprises a minimum mass target value, and wherein the condition comprises an estimated time for the at least one component to exhaust the available comminuted ore.

18. The method of claim 17, wherein the mass estimate comprises an estimate of a mass of ore in a surge pile.

19. The method of claim 6, wherein the condition comprises an operational state of the at least one component, the operational state determined by comparing the calculated value to the target value.

20. The method of claim 1 wherein the calculated value comprises an estimated mass throughput calculated for a component of the process line using mass measurements obtained from at least one mass measurement sensor located elsewhere on the process line, and wherein the correction comprises applying a corrective factor to future mass measurements, wherein the corrective factor is based upon a discrepency between the estimated mass throughput and an average of measurements of a component mass measurement sensor located at that component.

21. The method of claim 1 wherein the operating variable is adjusted to maintain a smooth variance in oil sand loads throughout the system.

22. A system for operating a slurry preparation process line for processing a bitumen-containing ore into a bitumen-containing slurry, comprising:
at least one measurement sensor at a location of the process line adapted to collect a plurality of measurements;
a central controller operative to compute a calculated value based on at least one of the plurality of measurements, and to apply an adjustment to an operating variable of a component of the process line to override a target setpoint of a regulatory controller for that component based on the calculated value and a target value for the calculated value.

23. The system of claim 22 further comprising a graphical user interface operative to display a representation of components of the process line, and further to display a representation of a condition at least one component, the condition based on the calculated value and the target value.

24. The system of claim 22 further comprising a graphical user interface operative to display a representation of components of the process line, wherein the calculated value comprises at least one throughput metric calculated for at least one component, and wherein the graphical user interface is further operative to display the at least one throughput metric at a location on the interface corresponding to that component.

25. A method of processing mined oil sand ore into a bitumen-containing slurry on a process line, comprising components of the process line performing the steps of:
a) receiving loads of mined oil sand ore;
b) transporting the loads of mined oil sand ore to a comminutor;
c) comminuting the loads of mined oil sand ore;
d) transporting the comminuted ore to a slurry apparatus; and,
f) processing the comminuted ore with process solvent in the slurry apparatus to generate a bitumen-containing slurry;
wherein a plurality of measurements at different component locations of the process line are obtained where one or more of steps (a) through (f) are performed, and wherein at least one component of the process line is locally controlled by a regulatory controller for that component to achieve a component target set-point for component based upon one or more of the plurality of measurements, and wherein the method further comprises a central controller:
g) computing a calculated value based on at least one of the plurality of measurements; and,
h) evaluating the calculated value with reference to a target value for the calculated value; and,
i) applying an adjustment to an operating variable of a component to override the target set-point for the component, the adjustment based on the evaluation of the calculated value and the target value.

26. A method comprising:
receiving a series of loads of mined oil sand containing bitumen into a system configured to process the loads of mined oil sand into a bitumen-containing slurry process stream output, wherein the system includes one or more operating constraints and wherein there are load fluctuations including variations in content and/or weight of each load and variations in duration of time between each load in the series;
obtaining a measurement at a measurement location in the system;
calculating a predicted value based on the measurement;
based on the measurement, the predicted value and at least one operating constraint, adjusting an operating condition of the system, wherein the adjustment minimizes the impact of the load fluctuations on a characteristic of the bitumen-containing slurry process stream output.

27. A method of processing mined oil sand ore into a bitumen-containing slurry on a process line, comprising components of the process line performing the steps of:
a) receiving loads of mined oil sand ore;
b) transporting the loads of mined oil sand ore to a comminutor;
c) comminuting the loads of mined oil sand ore;
d) transporting the comminuted ore to a slurry apparatus; and,
f) processing the comminuted ore with process solvent in the slurry apparatus to generate a bitumen-containing slurry;
g) obtaining a plurality of measurements from different components of the process line where one or more of steps (a) through (f) are performed;
h) based on the plurality of measurements, determining at least one calculated value; and,
i) adjusting with a central controller a set-point of a component of the process line based on the at least one calculated value, wherein the adjustment is selected to optimise an overall performance metric of the process line as a whole and an adjusted set-point is different than the set point of the component selected to optimise a local performance metric of the component individually.

28. A system operative to receive a series of loads of mined oil sand containing bitumen to process the loads of mined oil sand into a bitumen-containing slurry process stream output, wherein the system includes one or more operating constraints and wherein there are load fluctuations including variations in content and/or weight of each load and variations in duration of time between each load in the series, the system further comprising:
at least one measurement apparatus operative to obtain a measurement at a measurement location in the system;
a controller operative to calculate a predicted value based on the measurement and, based on the measurement, the predicted value and at least one operating constraint, to adjust an operating condition of the system, wherein the adjustment minimizes the impact of the load fluctuations on a characteristic of the bitumen-containing slurry process stream output.

29. The method of claim 7, wherein real time information of at least one of the plurality of measurements, the model, an estimated value, and a predicted value are displayed on the graphical user interface.

30. The method of claim 8, wherein real time information of at least one of the plurality of measurements, the model, an estimated value, and a predicted value are displayed on the graphical user interface.

31. The method of claim 9, wherein real time information of at least one of the plurality of measurements, the model, an estimated value, and a predicted value are displayed on the graphical user interface.
